(19) United States
(12) Patent Application Publication
(10) Pub. No.: US 2021/0060470 A1
(43) Pub. Date: Mar. 4, 2021

(54) COMBINED AIR FILTER ELEMENT FILTERING DEVICE

(71) Applicant: QAP FILTER (CHINA) LTD., Shanghai (CN)

(72) Inventors: Chao RAN, Shanghai (CN); Wujun DUAN, Nanchang City (CN); Xiaodong ZHAO, Shanghai (CN)

(21) Appl. No.: 16/918,149

(22) Filed: Jul. 1, 2020

(30) Foreign Application Priority Data
Aug. 29, 2019 (CN) 201910809322.3

(51) Int. Cl. B01D 46/00; B01D 46/52; B01D 46/12; B01D 46/54

(52) U.S. Cl. CPC B01D 46/0024; B01D 46/522; B01D 46/0008; B01D 46/12; B01D 46/543; B01D 2279/60; B01D 2267/70; B01D 2271/02; B01D 2275/205; B01D 2275/208; B01D 2267/40

(57) ABSTRACT

This present description discloses a combined air filter element filtering device, where the first filter element and second filter elements have a cube or cuboid shape. The second filter element and the first filter element are oriented in sagittal symmetry. The third filter element and the fourth filter element are oriented in symmetric distribution at the two sides of the first filter and second filter elements. The third filter element and the fourth filter element are in a semicircular or semi-arc ring structure. The first filter element, second filter element, third filter element and fourth filter element, when assembled into the combined air filter element device form a kidney-shaped or an oval three-dimensional ring-shaped combined air filter element filtering device. First, second, third and fourth filter elements are arranged to allow axial passage of air through the filter elements with decreased resistance and improved volume in order to reduce the air intake resistance in the filter element and increase the filter area so as to provide a combined air filter element filtering device of the same dimensions as conventional filters yet having a higher air inlet volume and improved clogging capacity, higher filtering efficiency and service life.

### RELATED APPLICATION

The instant application is related to and claims the benefit of priority to Chinese Patent Application serial number CN 201910809322.3, filed Aug. 29, 2019, the disclosure of which is herein fully incorporated by reference.

### FIELD OF THE DISCLOSURE

The present disclosure relates to an air filter device, and, in particular, to an axial flow combined air filter element for fluid filtering.

### BACKGROUND

Internal combustion engines rely on the combustion of air mixed with fuel in an engine cylinder to drive a piston which in turn causes rotation of a crankshaft coupled to the piston. Generally, prior to entering the cylinder, the air is filtered through a filtration device in order to remove particulate matter which may otherwise enter the cylinder and may cause damage to the engine. This removal of particulate matter helps to reduce mechanical wear of internal combustion engines due to the particulate matter, such as dust impurities carried in the air, and therefore improves the service life and efficiency and of the internal combustion engine.

Conventionally known filter elements are ring-shaped and are generally cylindrical and also consist of a single filter element. Such filter elements are generally formed by connecting the head and the tail of folded filter paper into a continuous loop, generally resulting in a hollow cylindrical shape. In terms of filtration of air, the air normally passes axially via an air inlet face oriented in the exterior axial direction of the filter element towards the hollow centre region of the cylindrical filter. Therefore, the hollow centre portion may not be fully utilized for air filtration. This may result in an inadequate or underutilized filter element surface area and thus a limited filter element service life.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for an air filter that overcomes some of the drawbacks of known techniques, or at least, provides a useful alternative thereto. Some aspects of this disclosure provide examples of such air filters with may more effectively utilize the filtering surface of the filtering membrane, which may be a filter paper, and thus improve the air filtering capacity of the filter element and the service life.

The present invention, in some embodiments, provides a combined air filter element filtering device having an axial flow air filter element which utilizes less space per filtering area, increases filter paper filtering area, thus an increased surface area to volume ratio, and which may extend the service life of the filtering device. Accordingly, the filtering device disclosed herein seeks to address at least some of the shortcomings and deficiencies which exist in certain currently available air filters.

Disclosed herein, in at least one aspect, is a combined air filter element filtering device where the combined air filter element filtering device comprises a first filter element, a second filter element, a third filter element and a fourth filter element, all of which are formed from wave-crest-trough folding of filter paper.

Briefly, the first filter element and the second filter element are formed in a cube or cuboid shape. The second filter element and the first filter element are oriented in sagittal symmetry. The third filter element and the fourth filter element are oriented in symmetric distribution at the two sides of the first filter and the second filter. The third filter element and the fourth filter element are formed into a semicircular or semi-arc ring conformation. The first filter element, the second filter element, the third filter element and the fourth filter element, in some embodiments, are arranged relative to one another so as to form a kidney-shape or an oval three-dimensional ring-shaped, or, in other words, as continuous loop filter element having a hollow centre portion.

The present invention discloses a combined air filter element filtering device, which seeks to overcome at least some of the shortcomings of inadequate utilization of the hollow center space in traditional ring-shaped cylindrical air filters. The first, second, third and fourth filters are provided to improve utilization of the hollow center portion; the upper and lower open end faces allow airflow to axially pass through the filter element, hence reducing the air intake resistance in the filter element and while increasing filter area and allowing a filter element of the similar dimensions to conventional filter elements yet having a higher air inlet volume and clogging capacity. Accordingly, achieving a higher filtering efficiency and capacity as well as an extended service life.

In accordance with one aspect, there is provided with a combined air filter element filtering device having an oval perimeter shape with a hollow center portion. The combined air filter element filtering device comprises a first filter element, a second filter element, a third filter element, and a fourth filter element. The first filter element and the second filter element have a generally cuboid shape and the third filter element and the fourth filter element have an elongated semicircular shape such that the third filter element has a third filter element arc internal peripheral face and the fourth filter element has a fourth filter element arc internal peripheral face. The third filter element and fourth filter element are arranged in a symmetric distribution near opposing ends of the combined air filter element filtering device such that the third filter element arc internal peripheral face and the fourth filter element arc internal peripheral face are oriented towards each other. The first filter element and the second filter element are arranged to intervene in the third filter element and fourth filter element in sagittal symmetry along opposing sides of the combined air filter element device.

In another aspect, there is provided with a combined air filter element filtering device, is characterized in that: a combined air filter element comprises a first filter element, a second filter element, a third filter element and a fourth filter element, which are all formed from wave-crest-trough folding of filter paper. The first filter element and the second filter element have a cuboid shape and the second filter element and the first filter element are in sagittal symmetry. The third filter element and the fourth filter element are in symmetric distribution at the two sides of the first filter and second filter and the third filter element and the fourth filter element have a semicircular structure. The first filter element, the second filter element, the third filter element and the fourth filter element constitute an oval three-dimensional ring-shaped filter element.

In some embodiments, at least one of the first filter element, the second filter element, or the third filter element, or the fourth filter element comprises a sheet of cellulose, a sheet of woven fabric, a sheet of polymer, or foam.

In some embodiments, least one of the first filter element, the second filter element, or the third filter element, or the fourth filter element comprised a material sheet formed into a repeating back and forth pattern of waves and troughs connected by crests. In some embodiments, in the crests are curves. In some embodiments, in the crests are folds.

In some embodiments, a fold depth of at least one of the first filter element or the second filter element is from about 1.1 to about 4 times that of a fold depth at least one of the third filter element or the fourth filter element.

In some embodiments, an upper end face of each of the first filter element, the second filter element, the third filter element, and the fourth filter element are consistent and lie in the same plane. In some embodiments, a lower end face of the first filter element, the second filter element or the third filter element, and the fourth filter element are consistent and lie in the same plane.

In some embodiments, the first filter element, the second filter element, or the third filter element, and the fourth filter element are connected by sealant joining respective left end faces and right ends faces.

In some embodiments, the combined air filter element filtering device further comprises a supporting framework cage structure disposed in the hollow centre portion for supporting the first filter element, the second filter element, the third filter element and the fourth filter element.

In some embodiments, at least one of a first filter element front end face of the first filter element, a second filter element back end face of the second filter element, the third filter element arc internal peripheral face of the third filter element and the fourth filter element arc internal peripheral face of the fourth filter element is secured to the supporting framework cage structure.

In some embodiments, the combined air filter element filtering device further comprises a ring-shaped upper fixing cover.

In some embodiments, the combined air filter element filtering device further comprises a seal portion for covering the hollow portion across a portion of respective upper end faces of the first filter element, the second filter element, the third filter element, and the fourth filter element.

In some embodiments, the combined air filter element filtering device further comprises a lower fixing seal ring.

In some embodiments, a first filter element back end face of the first filter element, a second filter element front end face of the second element, a third filter element arc external peripheral face of the third filter element, and a fourth filter element arc external peripheral face of the fourth filter element are inclined.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a top right side perspective view of the schematic construction of an embodiment of the combined air filter element filtering device as disclosed herein;

FIG. 2 is a top right side exploded perspective view of the combined air filter element filtering device of FIG. 1;

FIG. 3 is a top right side perspective view of the schematic construction of the first filter element of an embodiment of the combined air filter element filtering device of FIG. 2;

FIG. 4 is a top right side perspective view of the schematic construction of the second filter element of an embodiment of the combined air filter element filtering device of FIG. 2;

FIG. 5 is a top perspective view of the schematic constructions of the third and fourth filter elements of an embodiment of the combined air filter element filtering device of FIG. 2;

FIG. 6 is a right side elevational section view schematically showing airflow directions through an embodiment of the combined air filter element filtering device as disclosed herein;

FIG. 7 is a top plan view of FIG. 6 schematically showing airflow directions through an embodiment of the combined air filter element filtering device;

FIG. 8 is a right side perspective view of an exemplary embodiment of the internal and peripheral filter membrane support frameworks of the main support framework and third and fourth filter elements of FIG. 2; and

FIG. 9 is a top perspective schematic view of the construction of the seal and the lower fixing seal ring of FIG. 2.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are may not be depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various combined air filter element filtering devices 10 will be described below to provide examples of implementations of the system disclosed herein. No implementation described below limits any claimed implementation and any claimed implementations may cover processes or apparatuses that differ from those described below. The claimed implementations are not limited to devices or associated processes that have all of the features of any one device or associated processes described below or to features common to multiple or all of the devices or associated processes described below. It is possible that a device or associate process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this invention belongs.

Throughout the specification and claims, the following terms take the meanings explicitly associated herein unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the tern “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example, one or more further feature(s), component(s) and/or element(s) as appropriate.

The device or associated processes described herein provide, in accordance with the various embodiments, at least one exemplary embodiment of a combined filter element device 10.

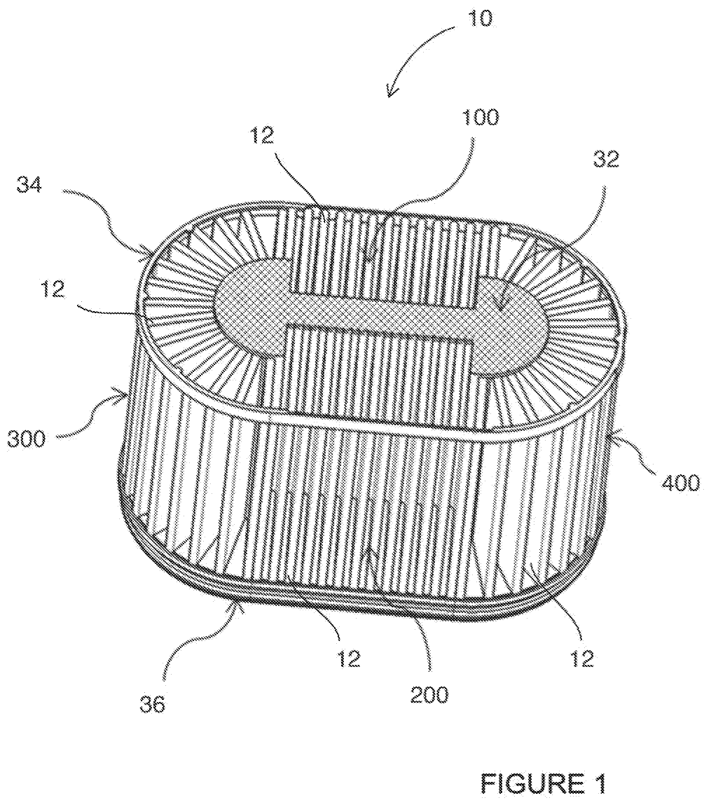

With reference to FIG. 1, and in accordance with one exemplary embodiment, a combined filter element device, generally referred to using the numeral 10, will now be described.

Disclosed herein is a combined air filter element filtering device 10, which seeks to overcome at least some of the drawbacks known with prior art devices. Briefly, and with reference to the figures and in particular FIG. 1, the combined air filter element filtering device 10 comprises a first filter element 100, a second filter element 200, a third filter element 300 and a fourth filter element 400, which are all formed from a wave-crest-trough folding of filter paper. Although in the instant disclosure, the filter elements are noted to be formed from filter paper, it is to be understood that other suitable filtering membranes 12 may be used. For example, suitable filter membranes 12 made from a sheet(s) of cellulose, woven fabric, polymer, foam etc., formed into a desired 3-dimensional shape as shown in the figures and described below so as to form the first filter element 100, the second filter element 200, the third filter element 300, and the fourth filter element 400.

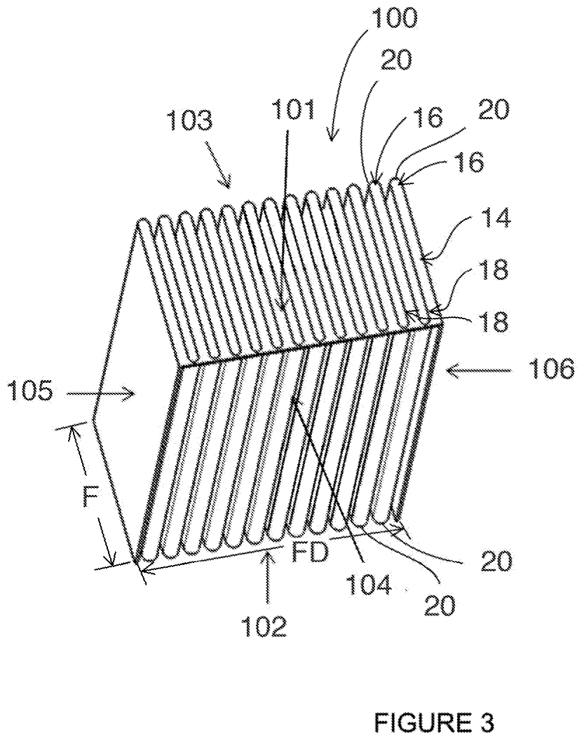

In preferred embodiments, such as those noted above, the first 100, second 200, third 300, and fourth 400 filter elements are formed by folding the filter membrane 12 into a wave-crest-trough 14 conformation as seen, for example in FIGS. 3, 4, and 5, thus in a repeating back and forth pattern. In such a wave-crest-trough 14 conformation, the surface area to volume ratio of each of the filter elements is increased by folding the filter membrane 12 to have a repeating series of waves 16 and troughs 18 which transition via an apex portion 20 from wave 16 to trough 18. In preferred embodiments, the apex portion 20 may be formed of a curve as shown in the figures. However, although not shown in the figures, the apex portion may be formed of a fold or crease.

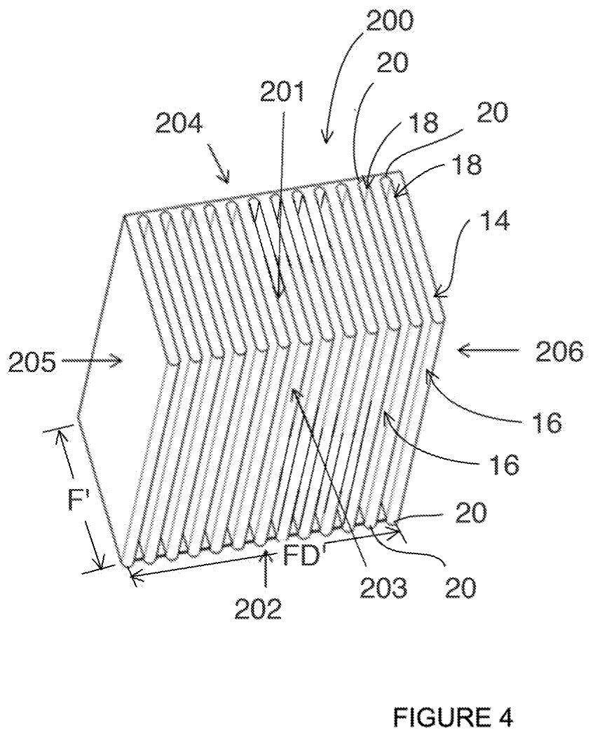

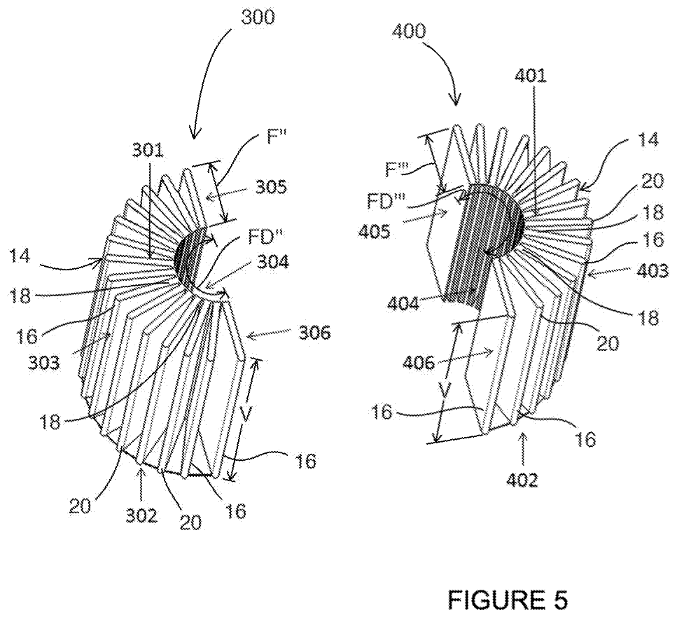

In preferred embodiments, the fold depth, for example along dimensions F and F′ of FIGS. 3 and 4, of first filter element 100 and second filter element 200 may be from about 20 mm to about 150 mm. The fold depth, for example along with dimensions F″ and F′″ of FIG. 5, of the third filter element 300 and the fourth filter element 400 may be from about 10 mm to about 100 mm. Also, the fold width, that being the distance between the waves 16 and troughs 18, in some embodiments, may be from about 50 mm to about 400 mm.

In order to more fully utilize the central part volume, or hollow centre portion, of the combined filter element, the fold depth of the first filter element 100 and the second filter element 200 is generally 1.1 to about 4 times of that of the third filter element 300 and the fourth filter element 400, so as to allow the first filter element 100 and the second filter element 200 to extend towards the hollow part as much as possible to increase filtering area.

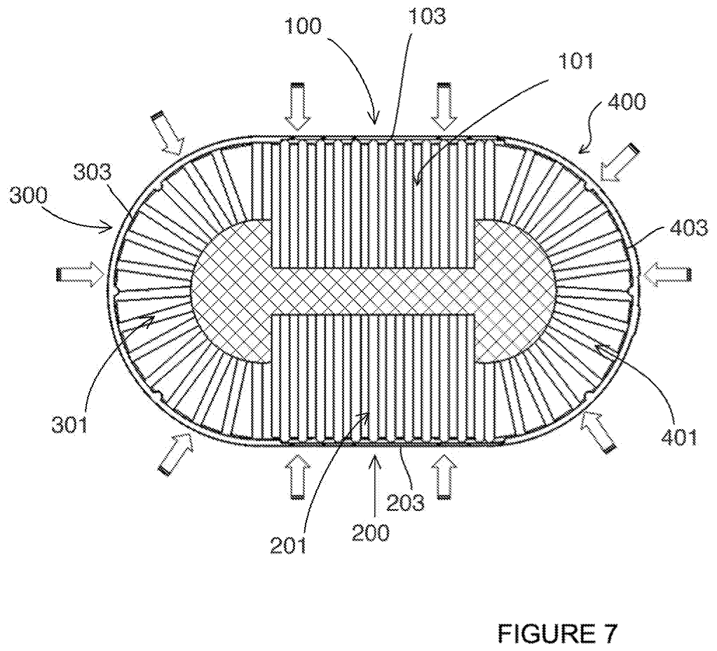

The first filter element 100 and the second filter element 200 are a cube or cuboid shape. The second filter element 200 and the first filter element 100 are oriented in sagittal symmetry; that being aligned on opposite lateral sides of the combined air filter element filtering device 10, as shown, for example, in FIGS. 1, 2, and 7. The third filter element 300 and the fourth filter element 400 have a semicircular or semi-arc ring structure as seen from a top or bottom view and elongated along with a vertical dimension V, as shown in FIG. 5, so as to form an elongated semicircular shape. The third filter element 300 and the fourth filter element 400 are oriented in symmetric distribution at the two sides of the first filter 100 and the second filter 200, as can be best seen in FIG. 7. The first filter element 100, the second filter element 200, the third filter element 300 and the fourth filter element 400 constitute a kidney-shaped or an oval three-dimensional ring-shaped filter element filtering device 10.

Turning now to the filter elements, the upper and lower end faces in the width of the fold of the first filter element 100 are respectively the filter element upper end face 101 and filter element lower end face 102, as shown, for example, in FIG. 3. The upper and lower end faces in the width of the fold of the second filter element 200, shown in FIG. 4, are respectively the second filter element upper end face 201 and second filter element lower end face 202. And the upper and lower end faces in the width of the fold of the third filter element 300 are respectively the third filter element upper end face 301 and third filter element lower end face 302; the upper and lower end faces in the width of the fold of the fourth filter element 400 are respectively the fourth filter element upper end face 401 and fourth filter element lower end face 402, as shown, for example in FIG. 5.

As shown in the figures, the orientations of the upper end face 101 of the first filter element, the upper end face 201 of the second filter element and the upper end face 401 of the fourth filter element are consistent and thus lie in the same plane and substantially the same elevation. Similarly, the orientations of the lower end face 102 of the first filter element 100, the lower end face 202 of the second filter element 200, the lower end face 302 of the third filter element 300 and the lower end face 402 of the fourth filter element 400 are consistent and thus lie in the same plane and substantially the same elevation, as can be seen in the figures.

The front and back end faces of the first filter element 100 in the depth of the fold direction shown by arrow F in FIG. 3 are respectively the opposing first filter element front end face 104 and first filter element back end face 103 and the left and right open edge end faces of the first filter element 100 in the folding direction shown by arrow FD in FIG. 3 are respectively the first filter element left end face 105 and first filter element right end face 106.

The front and back end faces of the second filter element 200 in the depth of the fold direction shown by arrow F′ in FIG. 4 are respectively the opposing second filter element back end face 204 and second filter element back end face 203 and the left and right open edge end faces of the second filter element 200 in the folding direction shown by arrow FD′ FIG. 4 are respectively the second filter element left end face 205 and second filter element right end face 206.

As shown in FIG. 5, the arc external peripheral face and the are internal peripheral face of the third filter element 300 in the fold direction shown by arrow F″ are respectively the third filter element arc external peripheral face 303 and the third filter element arc internal peripheral face 304. The two open edge faces of the third filter element 300 in the folding direction shown by arrow FD″ in FIG. 5 are, respectively, the third filter element right end face 305 and third filter element left end face 306.

As shown in FIG. 5, the arc external peripheral face and the arc internal peripheral face of the fourth filter element 400 in the fold direction shown by arrow F′″ are respectively the fourth filter element arc external peripheral face 403 and the fourth filter element arc internal peripheral face 404. The two open edge faces of the fourth filter element 400 in the folding direction shown by arrow FD′″ in FIG. 5 are, respectively, the fourth filter element right end face 405 and fourth filter element left end face 406.

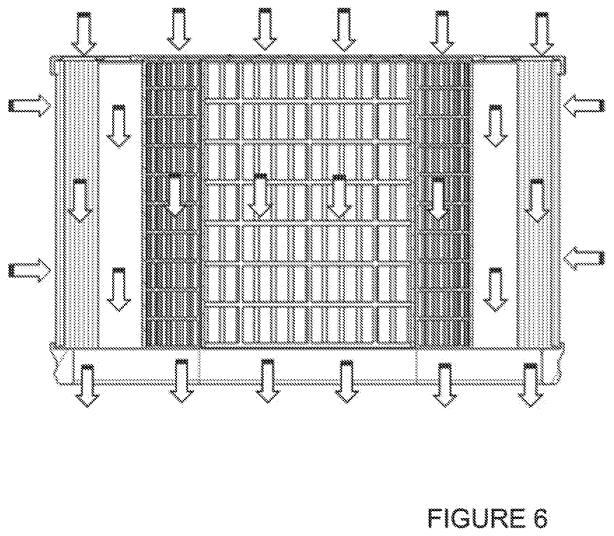

As will be appreciated from viewing the figures with regard to the airflow arrows, and in particular FIGS. 6 and 7, for ease of understanding, the first filter element upper end face 101 and the first filter element back end face 103 of the first filter element 100; the second filter element upper end face 201 and the second filter element front end face 203 of the second filter element 200; the third filter element upper end face 301 and third fitter element arc external peripheral face 303 of the third filter element 300; the fourth filter element upper end face 401 and the fourth filter element arc external peripheral face 403 of the fourth filter element 400 are all air inlet faces.

Conversely, the first filter element lower end face 102 and first filter element front end face 104 of the first filter element 100; the second filter element lower end face 202 and the second filter element back end face 204 of the second filter element 200; the third filter element lower end face 302 and the third filter element arc internal peripheral face 304 of the third filter element 300; the fourth filter element lower end face 402 and the fourth filter element arc internal peripheral face 404 of the fourth filter element 400 are all air outlet faces, as shown in FIG. 6. Thus, as shown in FIG. 6, in use, the combined filter element device 10 is designed such that airflow is inward to the hollow portion from the upper end faces of the first 100, second 200, third 300 and fourth 400 filter elements, and the back/external arc faces of the first 100, second 200, third 300 and fourth 400 filter element to egress from the bottom end faces of the first 100, second 200, third 300 and fourth 400 filter elements.

Conversely, the first filter element lower end face 102 and first filter element front end face 104; the second filter element lower end face 202 and the second filter element back end face 204; the third filter element lower end face 302 and the third filter element arc internal peripheral face 304; and the fourth filter element lower end face 402 and the fourth filter element arc internal peripheral face 404 may all be air inlet faces. And, thus, the first filter element upper end face 101 and the first filter element back end face 103; the second filter element upper end face 201 and the second filter element front end face 203; the third filter element upper end face 301 and the third filter element arc external peripheral face 303; the fourth filter element upper end face 401 and the fourth filter element arc external peripheral face 403 would all be air outlet faces. Accordingly, depending on the desired direction of air flow through the filter, a particular face may either be an unfiltered air ingress or a filtered air egress. Air flow direction through the filter may also be a function of the installed orientation of the combined air filter element filtering device 10 in a given application.

When assembled to form the combined air filter element filtering device 10, as shown, for example, in FIGS. 3, 5 and 7, the first filter element left end face 105 of the first filter element 100 in the folding direction F is adjoined with the third filter element right end face 305 of the third filter element 300 through sealant or glue or other means so as to stop unfiltered air from passing between a gap between the fourth filter element left end face 105 and the third filter element right end face 305. Similarly, the first filter element right end face 106 is adjoined with the fourth filter element left end face 405 of the fourth filter element 400 through suitable means so as to stop unfiltered air from passing through a gap between the first filter element right end face 106 and the fourth filter element left end face 405 of the fourth filter element.

Turning now to FIGS. 4, 5, and 7, the second filter element left end face 205 of the second filter element 200 in the folding direction F is adjoined with the third filter element left end face 306 of the third filter element 300 through means as noted above, or other suitable means as may be known in the art, with regard to the adjoining of the various filter elements so as to stop unfiltered air from passing through a gap between the second filter element left end face 205 and the third filter element left end face 306. The second filter element right end face 206 in the folding direction F is adjoined with the fourth filter element right end face 406 of the fourth filter element 400 through, for example, a sealant, as noted above so as to stop unfiltered air from passing through a gap between the second filter element right end face 206 and the fourth filter element right end face 406.

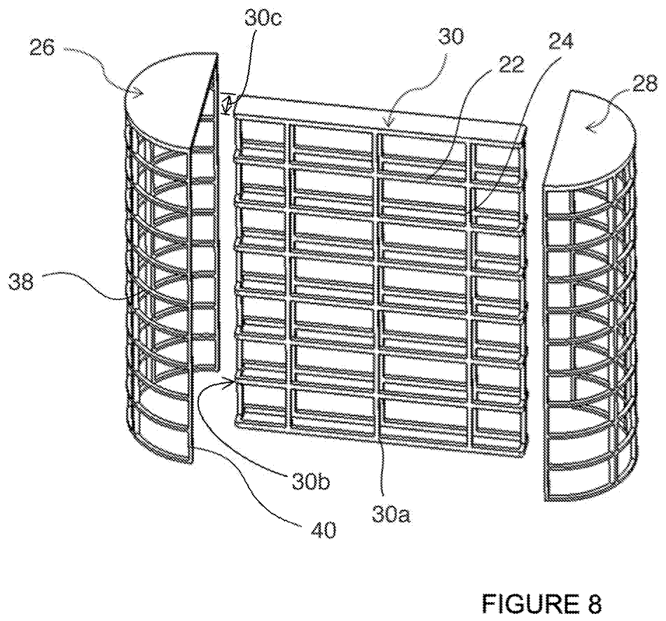

Referring now to FIG. 8, for the purpose of support and aiding in the fixation of the various filter elements, a main support framework 30 is provided between the first filter element 100 and the second filter element 200. The main support framework 30, for example, may be a rectangular framework structure having a cross-distribution of a plurality of horizontally distributed horizontal support ribs 22 and a plurality of vertically distributed vertical support ribs 24, which form air passage routes via the voids formed between horizontal support ribs 22 and vertical support ribs 24. The first filter element front end face 104 of the first filter element 100 and the second filter element back end face 204 of the second filter element 200 respectively fit with the respective front 30a and back 30b end faces of the main support framework 30. The main support framework 30, for example, can be made from any suitable material, such as metal, plastics, etc. For example, the main support framework 30 may be made by plastic injection molding or metal sheet compression molding. Furthermore, the spacing between the main support framework front face 30a and the main support framework back face 30b, for example, the hollow width 30c of the support framework, in various embodiments, may be from about 10 mm to about 100 mm, however, other dimensions may be possible and desired for various applications.

Continuing now also with FIG. 8, for the purpose of support and aiding in the fixation of the various filter elements, a third filter element internal peripheral support framework 26 for supporting the third filter element 300 is provided. The third filter element internal peripheral support framework 26 is provided, for example, having a semi-circle or semi-arc area face to substantially complimentarily receive thereon the face the third filter element arc internal peripheral face 304 of the third filter element 300 and portions of first filter element front end face 104 and the second filter element back end face 204. Similar to the main support framework 30, the third filter element internal peripheral support framework 26 may be provided as a hollow framework structure, of which the framework shape fits with the shape of the third filter element arc internal peripheral face 304 of the third fitter element 300. Furthermore, the third filter element internal peripheral support framework 26 may be made from any suitable material and in certain embodiments, is made by plastics material injection molding or metal sheet compression molding. Additionally, in various embodiments, the radius of the hollow semi-arc of the framework may be from about 10 to about 80 mm, however, other dimensions may be possible and desired for various applications.

Similar to the third filter element internal peripheral support framework 26, the fourth filter element internal peripheral support framework 28 is provided. The fourth filter element internal peripheral support framework 28 is provided, for example, having a semi-circle or semi-arc area face to substantially complimentarily receive thereon the face the fourth filter element arc internal peripheral face 404 of the fourth filter element 400 and portions of first filter element front end face 104 and the second filter element back end face 204. Similar to the third filter element internal peripheral support framework 26, the fourth filter element internal peripheral support framework 28 may be provided as a hollow framework structure, of which the framework shape fits with the shape of the fourth filter element arc internal peripheral face 404 of the fourth filter element 400. Furthermore, the fourth filter element internal peripheral support framework 28 may be made from any suitable material and in certain embodiments, is made by plastics material injection molding or metal sheet compression molding. Additionally, in various embodiments, the radius of the hollow semi-arc of the framework may be from about 10 to about 80 mm, however, other dimensions may be possible and desired for various applications.

As part of the combined air filter element filtering device 10, the fourth filter element internal peripheral support framework 28, and third filter element internal peripheral support framework 26, preferred embodiments are provided as having the same shape and in symmetric distribution relative one another. Furthermore, in preferred embodiments, as shown in FIG. 8, for example the fourth filter element internal peripheral support framework 28, and the third filter element internal peripheral support framework 26, are formed from a plurality of semi-circle or semi-arc horizontal ribs 38 from top to bottom in equal spacing. A vertical rib 40 is provided and coupled at each of the two ends of each horizontal rib 38. In preferred embodiments, more intervening vertical ribs 40 and horizontal ribs 38 are provided and fixed, or coupled, with each other so as to form an integrated structure. Accordingly, as shown in FIG. 8, it may be said that cage-like structure is thus formed into a mesh of the interconnected horizontal ribs 38 and the vertical ribs 40.

Although not shown in the figures, an adhesive sealant is provided along a portion of the first filter element front end face 104, the second filter element back end face 204, the third filter element arc internal peripheral face 304, and the fourth filter element arc internal peripheral face 404, respectively near the first filter element upper end face 101, the second filter element upper end face 201, the third filter element upper end face 301 and the fourth filter element upper end face 401. Also, an adhesive sealant is provided along a portion of the first filter element front end face 104, the second filter element back end face 204, the third filter element arc internal peripheral face 304, and the fourth filter element arc internal peripheral face 404, respectively near the first filter element lower end face 102, the second filter element lower end face 202, the third filter element lower end face 302 and the fourth filter element lower end face 402. The adhesive sealant is provided for coupling the portion of the filter elements to the main support framework 30, the third filter element internal peripheral support framework 26 and the fourth filter element internal peripheral support framework 28. Generally, the adhesive sealant is provided to the apex portions 20 of the filter elements and then contacted with the respective main support framework 30, the third filter element internal peripheral support framework 26 and the fourth filter element internal peripheral support framework 28 so as to couple thereto. In some embodiments, the adhesive is applied along the length of the apex portions 20. In some embodiments, the adhesive applied intermediately along the apex portions 20.

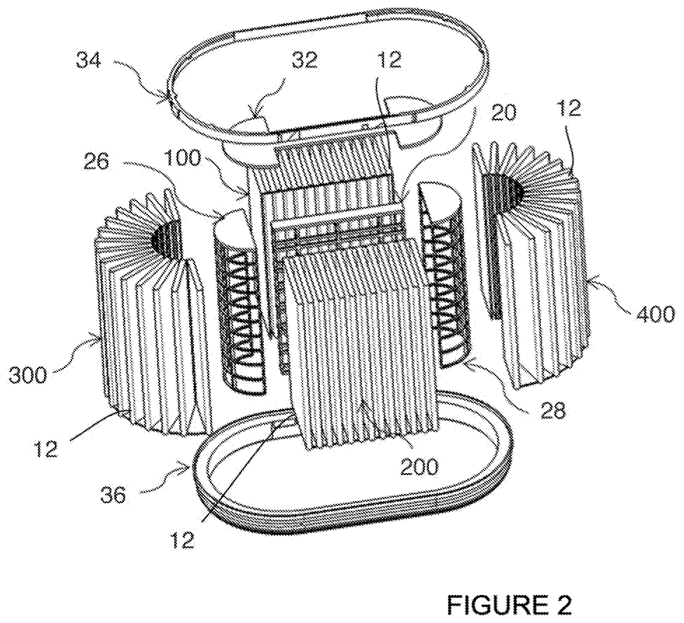

Referring to FIG. 2, the upper end faces of the main support framework 30, fourth filter element internal peripheral support framework 28 of the fourth filter element 400 and the third filter element internal peripheral support framework 26 of the third filter element 300, in some embodiments, are covered by seal portion 32. The seal portion 32, as shown in the top plan view of FIG. 7, is provided with dimensions suitable to cover over a portion of the first filter element upper end face 101 of the first filter element 100, a portion of the second filter element upper end face 201 of the second filter element 200, a portion of the third filter element upper end face 301 of the third filter element 300, and a portion of the fourth filter element upper end face 401 of the fourth filter element 400 so as to inhibit, or at least substantially prevent unfiltered air from passing between gaps between the first filter element 100, the second filter element 200, the third filter element 300, the fourth filter element 400 and the main support framework 30, the fourth filter element internal peripheral support framework 28, the internal peripheral support framework 26. For example, as can be seen in FIG. 7, the exterior dimensions of seal portion 32 cover the apex portions 20 of the various filter elements along with the first filter element upper end face 101, a portion of the second filter element upper end face 201, a portion of the third filter element upper end face 301, and a portion of the fourth filter element upper end face 401.

In order to assist in maintaining the various filter elements in the desired relationships in the combined air filter element filtering device 10, the first filter element upper end face 101 of the first filter element 100, the second filter element upper end face 201 of the second filter element 200, the third filter element upper end face 301 of the third filter element 300 and the fourth filter element upper end face 401 of the fourth filter element 400, as shown FIG. 1 and in the exploded view of FIG. 2, are bordered and bound by an upper fixing cover 34. The upper fixing cover 34, in preferred embodiments, may be provided as a ring-shaped structure where the upper fixing cover 34 is firmly tightened to the outer edge of the upper plane of the various filter elements. Furthermore, the upper fixing cover 34 may also assist in preventing impact damage during the course of transport or to the open upper end faces 101, 201, 301 and 401 of the filter paper or filter element membranes.

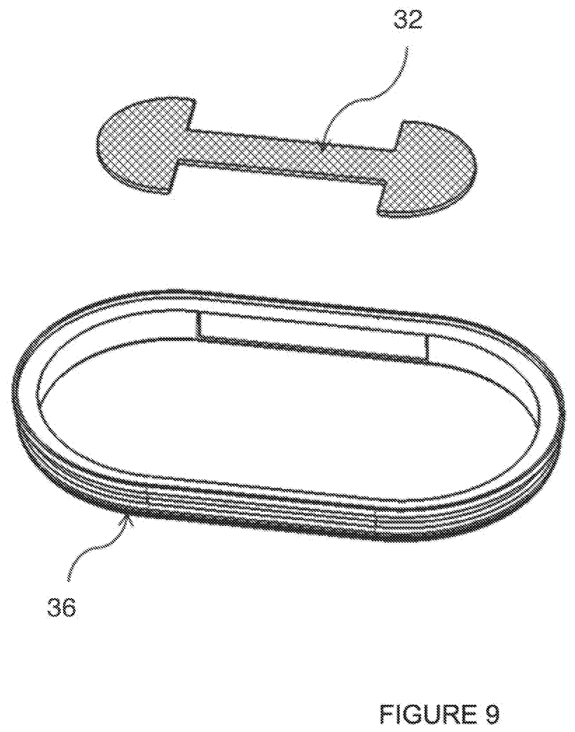

Similarly, the first filter element lower end face 102 of the first filter element 100, the second filter element lower end face 202 of the second filter element 200, the third filter element lower end face 302 of the third filter element 300 and the fourth filter element lower end face 402 of the fourth filter element 400 are bordered and bound by a lower fixing seal ring 36 about an outer edge of the lower plane. As shown, for example in FIG. 2 and FIG. 9, the lower fixing seal ring 36 may be provided in a ring-shaped structure. Furthermore, the lower fixing seal ring 36, in preferred embodiments, provided as a ring-shaped structure, is firmly tightened to the outer edge of the lower plane of the various filter elements. Furthermore, the lower fixing seal ring 36 may also assist in preventing impact damage during the course of transport or to the open lower end faces 101, 201, 301 and 401 of the filter paper.

In use, air can pass through the first filter element back end face 103 of the first filter element 100 and reach the first filter element front end face 104, and flow out into the hollow of the main support framework 30 after filtering. Air can pass through the second filter element front end face 203 of the second filter element 200 and reach the second element back end face 204 and flow out into the hollow of the main support framework 30 after filtering. Also, air can pass through the third filter element arc external peripheral face 303 of the third filter element 300 and reach the third filter element arc internal peripheral face 304, and after filtering flow out of the semi-circle or semi-arc into the hollow formed between the third filter element 300 and the first filter element 100, the second filter element 200. And finally, air can pass through the fourth filter element arc external peripheral face 403 of the fourth filter element 400 and reach the fourth filter element arc internal peripheral face 404 and flow out into the hollow of the semi-circle or semi-arc formed between the fourth filter element 400 and the first filter element 100, the second filter element 200, after filtering.

Additionally, the periphery edge-center distance of the first filter element 100, the second filter element 200, the third filter element 300 and the fourth filter element 400 gradually increase in the central axis direction of the combined air filter element filtering device 10 from the filter element upper end faces 101, 201, 301, and 401 of the filter element lower end faces 102, 202, 302, and 402. Therefore, the external contour of the combined filter element 10 may have incline sides or, in other words, is larger at one end and smaller at the other end. The inclined sides, and thus a frusto-funnel shape, may provide for easier air induction into the combined filter element and filtered air egress as compared to a filer no have incline sides.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases, the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A combined air filter element filtering device having an oval perimeter shape with a hollow center portion comprising: a first filter element, a second filter element, a third filter element, and a fourth filter element;
the first filter element and the second filter element having a generally cuboid shape;
the third filter element and the fourth filter element having an elongated semicircular shape such that the third filter element has a third filter element arc internal peripheral face and the fourth filter element has a fourth filter element arc internal peripheral;
the third filter element and fourth filter element arranged in a symmetric distribution near opposing ends of the combined air filter element filtering device such that the third filter element arc internal peripheral face and the fourth filter element arc internal peripheral face are oriented towards each other;
the first filter element and the second filter element arranged to intervene the third filter element and fourth filter element in sagittal symmetry along opposing sides of the combined filter element device.

2. The combined air filter element filtering device of claim 1, wherein at least one of the first filter element, the second filter element, or the third filter element, or the fourth filter element comprises a sheet of cellulose, a sheet of woven fabric, a sheet of polymer, or foam.

3. The combined air filter element filtering device of claim 1, wherein at least one of the first filter element, the second filter element, or the third filter element, or the fourth filter element comprised a material sheet formed into a repeating back and forth pattern of waves and troughs connected by crests.

4. The combined air filter element filtering device of claim 3, wherein in the crests are curves.

5. The combined air filter element filtering device of claim 3, wherein in the crests are folds.

6. The combined air filter element filtering device claim 1, wherein a fold depth of at least one of the first filter element or the second filter element is from about 1.1 to about 4 time that of a fold depth at least one of the third filter element or the fourth filter element.

7. The combined air filter element filtering device of claim 1, wherein an upper end face of each of the first filter element, the second filter element, the third filter element, and the fourth filter element are consistent and lie in the same plane.

8. The combined air filter element filtering device of claim 1, wherein a lower end face of the first filter element, the second filter element or the third filter element, and the fourth filter element are consistent and lie in the same plane.

9. The combined air filter element filtering device of claim 1, wherein the first filter element, the second filter element, or the third filter element, and the fourth filter element are connected by sealant joining respective left end faces and right ends faces.

10. The combined air filter element filtering device of claim 1, further comprising a supporting framework cage structure disposed in the hollow centre portion for supporting the first filter element, the second filter element, the third filter element and the fourth filter element.

11. The combined air filter element filtering device of claim 10, wherein at least one of a first filter element front end face of the first filter element, a second filter element back end face of the second filter element, the third filter element arc internal peripheral face of the third filter element and the fourth filter element arc internal peripheral face of the fourth filter element are secured to the supporting framework cage structure.

12. The combined air filter element filtering device of claim 1, further comprising a ring-shaped upper fixing cover.

13. The combined air filter element filtering device of claim 1, further comprising a seal portion for covering the hollow portion across a portion of respective upper end faces of the first filter element, the second filter element, the third filter element, and the fourth filter element.

14. The combined air filter element filtering device of claim 1, further comprising a lower fixing seal ring.

15. The combined filter element filtering device of claim 1, wherein a first filter element back end face of the first filter element, a second filter element front end face of the second element, a third filter element arc external peripheral face of the third filter element, and a fourth filter element arc external peripheral face of the fourth filter element are inclined.

16. A combined air filter element filtering device, characterized in that: a combined air filter element comprises a first filter element, a second filter element, a third filter element and a fourth filter element, which are all formed from wave-crest-trough folding of filter paper;
the first filter element and the second filter element having a cuboid shape;
the second filter element and the first filter element being in sagittal symmetry;
the third filter element and the fourth filter element being in symmetric distribution at the two sides of the first filter and second filter;
the third filter element and the fourth filter element having a semicircular structure;
the first filter element, the second filter element, the third filter element and the fourth filter element constitute an oval three-dimensional ring-shaped filter element.

17. The combined air filter element filtering device of claim 16, characterized in that: upper and lower end faces in the width of the wave-crest-trough folding of the first filter element are respectively a first filter element upper end face and a first filter element lower end face;
upper and lower end faces in the width of the wave-crest-trough folding of the second filter element are respectively a second filter element upper end face and a second filter element lower end face;
upper and lower end faces in the width of wave-crest-trough folding of the third filter element are respectively a third filter element upper end face and a third filter element lower end face;
upper and lower end faces in the width of the wave-crest-trough folding of the fourth filter element are respectively a fourth filter element upper end face and a fourth filter element lower end face;
the orientations of the first filter element upper end face, the second filter element upper end face, the third filter element upper end face, and the fourth upper end face are consistent;
the orientations of the first filter element lower end face, the second filter element lower end face, the third filter element lower end face, and the fourth filter element lower end face are consistent;
the front and back end faces of the first filter element in the depth of the wave-crest-trough folding are respectively a first filter element front end face and a first filter element back end face; left and right open edge end faces of the first filter element in the folding direction are respectively a first filter element left end face and a first filter element right end face;
the front and back end faces of the second filter element in the depth of the wave-crest-trough folding are respectively a second filter element front end face and a second filter element back end face; left and right open edge end faces of the second filter element in the folding direction are respectively a second filter element left end face and a second filter element right end face;
the arc external peripheral face and the arc internal peripheral face of the third filter element in the depth of the wave-crest-trough fold are respectively a third filter element arc external peripheral face and a third filter element arc internal peripheral face; the two open edge faces of the third filter element in the folding direction are respectively a third filter element right end face and third filter element left end face;
the arc external peripheral face and the arc internal peripheral face of the fourth filter element in the depth of the wave-crest-trough fold are respectively a fourth filter element arc external peripheral face and a fourth filter element arc internal peripheral face; the two open edge faces of the fourth filter element in the folding direction are respectively a fourth filter element right end face and fourth filter element left end face;
the first filter element upper end face and the first filter element back end face, the second filter element upper end face and the second filter element front end face, the third filter element upper end face and the third filter element arc external peripheral face, the fourth filter element upper end face and the fourth filter element arc external peripheral face are all air inlet faces;
the first filter element lower end face and the first filter element front end face, the second filter element lower end face and the second filter element back end face, the third filter element lower end face and the third filter element arc internal peripheral, the fourth filter element lower end face and the fourth filter element arc internal peripheral face of the fourth filter element are all air outlet faces.

18. The combined air filter element filtering of claim 17 characterized in that: the first filter element left end face in the folding direction being connected with the third filter element right end face by a sealant so as to prevent unfiltered air from passing through the gap between the first filter element left end face and the third filter element right end face;
the first filter element right end in the folding direction also being connected with the fourth filter element left end face through sealant to so as to prevent unfiltered air from passing through the gap between the first filter element right end face and the fourth filter element left end face;
the second filter element left end face in the folding direction being connected with the third filter element left end face also by sealant so as to prevent unfiltered air from passing through the gap between the second filter element left end face and the third filter element left end face;
the second filter element right end face in the folding direction being connected with the fourth filter element right end face also by sealant so as to prevent unfiltered air from passing through the gap between the second filter element right end face and the fourth filter element right end face.

19. The combined air filter element filtering device of claim 17, characterized in that: a main support framework is provided between the first filter element and the second filter element;
the main support framework being formed as a rectangular framework structure of cross-distribution of a plurality of horizontally distributed horizontal support ribs and a plurality of vertically distributed vertical support ribs such that air vents are formed between horizontal support ribs and vertical support ribs; the first filter element front end and the second filter element back end face respectively fit with the front and back end faces of the main support framework;
a third filter element internal peripheral support framework is provided in a semi-circular area formed between the arc third filter element internal peripheral face and the first filter element and the second filter element; the third filter element internal peripheral support framework being a hollow framework structure having a radius and shape complementary to the third filter element arc internal peripheral face;
a fourth filter element internal peripheral support framework is provided in a semi-circular area formed between the arc fourth filter element internal peripheral face and the first filter element and the second filter element; the fourth filter element internal peripheral support framework being a hollow framework structure having a radius and shape complementary to the fourth filter element arc internal peripheral face.

20. The combined air filter element filtering device of claim 17, characterized in that: the sealant sealing is provided between neighboring filter paper fold-fins at an inner edge of the first filter element upper end face that fits with the main support framework; the sealant sealing is provided between the neighboring filter paper fold-fins at an outer edge of the first filter element lower end face; the sealant sealing is provided between the neighboring filter paper fold-fins at an inner edge of the second filter element upper end face that fits with the main support framework; the sealant sealing is provided between the neighboring filter paper fold-fins at an outer edge of the second filter element lower end face; the sealant sealing is provided between the neighboring filter paper fold-fins that fit the semi-circular internal periphery of the third filter element upper end face the third filter element internal peripheral support framework; the sealant sealing is provided between the neighboring filter paper fold-fins at the semi-circular external periphery of the third filter element lower end face; the sealant sealing is provided between the neighboring filter paper fold-fins that fit the semi-circular folded paper internal periphery of the fourth filter element upper end face with the fourth filter element internal peripheral support framework; the sealant sealing is provided between the neighboring filter paper fold-fins at the semi-circular folded paper fourth filter element external periphery of the lower end face.

21. The combined air filter element filtering device of claim 19, characterized in that: the upper end face of the said main support framework, the fourth filter element internal peripheral support framework and the third filter element internal peripheral support framework is covered with a layer of sealant so as to form a seal structure at seams between the sealant and the first filter element upper end face, the second filter element upper end face, the third filter element upper end face, and the fourth filter element upper end face so as to prevent unfiltered air from passing through the gaps between the first filter element, the second filter element, the third filter element, the fourth filter element and the main support framework, the fourth filter element internal peripheral support, and the fourth filter element internal peripheral support framework.

22. The combined air filter element filtering device of claim 17 characterized in that: the outer edge of the upper plane is provided with an upper fixing cover having a ring-shaped structure; wherein the upper fixing cover is firmly tightened to the outer edge of the upper plane the first filter element upper end face, the second filter element upper end face, the third filter element upper end face, and the fourth filter element upper end face in the same upper plane of the air filter element device.

23. The combined air filter element filtering device of claim 17 characterized in that: the outer edge of the lower plane is provided with a lower fixing seal ring having a ring-shaped structure; wherein the lower fixing seal ring is firmly tightened to the outer edge of the lower plane the first filter element lower end face, the second filter element lower end face, the third filter element lower end face, and the fourth filter element lower end face in the same lower plane of the air filter element device.

24. The combined air filter element filtering device of claim 18, characterized in that: the fourth filter element internal peripheral support and the third filter element internal peripheral support framework have the same shape and are in symmetric distribution;
the third filter element internal peripheral support framework and fourth filter element internal peripheral support framework comprising a plurality of semi-circular horizontal ribs distributed from top to bottom in equal spacing; opposing ends of each horizontal rib being respectively provided with a respective vertical rib wherein the vertical ribs and the horizontal ribs are fixed with each other at respective conjunction points;
a middle point of each horizontal rib being further distributed with one or more intervening vertical ribs wherein each intervening vertical rib is coupled with each horizontal rib at respective conjunction points so as to form an integrated structure.

25. The combined air filter element filtering device of claim 16, characterized in that: upper and lower end faces in the width of the wave-crest-trough folding of the first filter element are respectively a first filter element upper end face and a first filter element lower end face;
upper and lower end faces in the width of the wave-crest-trough folding of the second filter element are respectively a second filter element upper end face and a second filter element lower end face;
upper and lower end faces in the width of wave-crest-trough folding of the third filter element are respectively a third filter element upper end face and a third filter element lower end face;
upper and lower end faces in the width of the wave-crest-trough folding of the fourth filter element are respectively a fourth filter element upper end face and a fourth filter element lower end face;
the orientations of the first filter element upper end face, the second filter element upper end face, the third filter element upper end face, and the fourth upper end face are consistent;
the orientations of the first filter element lower end face, the second filter element lower end face, the third filter element lower end face, and the fourth filter element lower end face are consistent;
front and back end faces of the first filter element in the depth of the wave-crest-trough folding are respectively a first filter element front end face and a first filter element back end face; left and right open edge end faces of the first filter element in the folding direction are respectively a first filter element left end face and a first filter element right end face;
front and back end faces of the second filter element in the depth of the wave-crest-trough folding are respectively a second filter element front end face and a second filter element back end face; left and right open edge end faces of the second filter element in the folding direction are respectively a second filter element left end face and a second filter element right end face;
the arc external peripheral face and the arc internal peripheral face of the third filter element in the depth of the wave-crest-trough fold are respectively a third filter element arc external peripheral face and a third filter element arc internal peripheral face; the two open edge faces of the third filter element in the folding direction are respectively a third filter element right end face and third filter element left end face;
the arc external peripheral face and the arc internal peripheral face of the fourth filter element in the depth of the wave-crest-trough fold are respectively a fourth filter element arc external peripheral face and a fourth filter element arc internal peripheral face; the two open edge faces of the fourth filter element in the folding direction are respectively a fourth filter element right end face and fourth filter element left end face;
the first filter element upper end face and the first filter element back end face, the second filter element upper end face and the second filter element front end face, the third filter element upper end face and the third filter element arc external peripheral face, the fourth filter element upper end face and the fourth filter element arc external peripheral face are all air outlet faces;
the first filter element lower end face and the first filter element front end face, the second filter element lower end face and the second filter element back end face, the third filter element lower end face and the third filter element arc internal peripheral, the fourth filter element lower end face and the fourth filter element arc internal peripheral face of the fourth filter element are all air inlet faces.

26. The combined air filter element filtering of claim 25 characterized in that: the first filter element left end face in the folding direction being connected with the third filter element right end face by a sealant so as to prevent unfiltered air from passing through the gap between the first filter element left end face and the third filter element right end face;
the first filter element right end in the folding direction also being connected with the fourth filter element left end face through sealant to so as to prevent unfiltered air from passing through the gap between the first filter element right end face and the fourth filter element left end face;
the second filter element left end face in the folding direction being connected with the third filter element left end face also by sealant so as to prevent unfiltered air from passing through the gap between the second filter element left end face and the third filter element left end face;
the second filter element right end face in the folding direction being connected with the fourth filter element right end face also by sealant so as to prevent unfiltered air from passing through the gap between the second filter element right end face and the fourth filter element right end face.

27. The combined air filter element filtering device of claim 25, characterized in that: a main support framework is provided between the first filter element and the second filter element;
the main support framework being formed as a rectangular framework structure of cross-distribution of a plurality of horizontally distributed horizontal support ribs and a plurality of vertically distributed vertical support ribs such that air vents are formed between horizontal support ribs and vertical support ribs; the first filter element front end and the second filter element back end face respectively fit with the front and back end faces of the main support framework;
a third filter element internal peripheral support framework is provided in a semi-circular area formed between the arc third filter element internal peripheral face and the first filter element and the second filter element; the third filter element internal peripheral support framework being a hollow framework structure having a radius and shape complementary to the third filter element arc internal peripheral face;
a fourth filter element internal peripheral support framework is provided in a semi-circular area formed between the arc fourth filter element internal peripheral face and the first filter element and the second filter element; the fourth filter element internal peripheral support framework being a hollow framework structure having a radius and shape complementary to the fourth filter element arc internal peripheral face.

28. The combined air filter element filtering device of claim 25, characterized in that: the sealant sealing is provided between neighboring filter paper fold-fins at an inner edge of the first filter element upper end face that fits with the main support framework; the sealant sealing is provided between the neighboring filter paper fold-fins at an outer edge of the first filter element lower end face; the sealant sealing is provided between the neighboring filter paper fold-fins at an inner edge of the second filter element upper end face that fits with the main support framework; the sealant sealing is provided between the neighboring filter paper fold-fins at an outer edge of the second filter element lower end face; the sealant sealing is provided between the neighboring filter paper fold-fins that fit the semi-circular internal periphery of the third filter element upper end face the third filter element internal peripheral support framework; the sealant sealing is provided between the neighboring filter paper fold-fins at the semi-circular external periphery of the third filter element lower end face; the sealant sealing is provided between the neighboring filter paper fold-fins that fit the semi-circular folded paper internal periphery of the fourth filter element upper end face with the fourth filter element internal peripheral support framework; the sealant sealing is provided between the neighboring filter paper fold-fins at the semi-circular folded paper fourth filter element external periphery of the lower end face.

29. The combined air filter element filtering device of claim 27, characterized in that: the upper end face of the said main support framework, the fourth filter element internal peripheral support framework and the third filter element internal peripheral support framework is covered with a layer of sealant so as to form a seal structure at seams between the sealant and the first filter element upper end face, the second filter element upper end face, the third filter element upper end face, and the fourth filter element upper end face so as to prevent unfiltered air from passing through the gaps between the first filter element, the second filter element, the third filter element, the fourth filter element and the main support framework, the fourth filter element internal peripheral support, and the fourth filter element internal peripheral support framework.

30. The combined air filter element filtering device of claim 25 characterized in that: the outer edge of the upper plane is provided with an upper fixing cover having a ring-shaped structure; wherein the upper fixing cover is firmly tightened to the outer edge of the upper plane the first filter element upper end face, the second filter element upper end face, the third filter element upper end face, and the fourth filter element upper end face in the same upper plane of the air filter element device.

31. The combined air filter element filtering device of claim 25 characterized in that: the outer edge of the lower plane is provided with a lower fixing seal ring having a ring-shaped structure; wherein the lower fixing seal ring is firmly tightened to the outer edge of the lower plane the first filter element lower end face, the second filter element lower end face, the third filter element lower end face, and the fourth filter element lower end face in the same lower plane of the air filter element device.

32. The combined air filter element filtering device of claim 27, characterized in that: the fourth filter element internal peripheral support and the third filter element internal peripheral support framework have the same shape and are in symmetric distribution;
the third filter element internal peripheral support framework and fourth filter element internal peripheral support framework comprising a plurality of semi-circular horizontal ribs distributed from top to bottom in equal spacing; opposing ends of each horizontal rib being respectively provided with a respective vertical rib wherein the vertical ribs and the horizontal ribs are fixed with each other at respective conjunction points;
a middle point of each horizontal rib being further distributed with one or more intervening vertical ribs wherein each intervening vertical rib is coupled with each horizontal rib at respective conjunction points so as to form an integrated structure.
